(19) United States
(12) Patent Application Publication
(10) Pub. No.: US 2009/0040036 A1
(43) Pub. Date: Feb. 12, 2009

(54) VEHICULAR WARNING SYSTEM AND METHOD OF SIGNAGE

(76) Inventor: Yefin Talis, Dallas, TX (US)

Correspondence Address: WINSTEAD PC, P.O. BOX 50784, DALLAS, TX, 75201, US

(21) Appl. No.: 12/170,926

(22) Filed: Jul. 10, 2008

Related U.S. Application Data
(60) Provisional application No. 60/964,093, filed on Aug. 9, 2007.
(60) Provisional application No. 60/959,975, filed on Jul. 18, 2007.

(51) Int. Cl. B60Q 1/00

(52) U.S. Cl. 340/457.1

(57) ABSTRACT

A vehicle alarm system for alerting occupants when an infant is left unattended on a child seat within a vehicle. The system comprising a plurality of buckles disposed on the child seat, at least one switch coupled to the plurality of buckles, a visual alerting device, a speaker, and wherein when at least one buckle of the plurality of buckles is engaged for a predetermined time period after a vehicle ignition is turned-off, the at least one switch transmits a signal activating the visual alerting device and the speaker.

### CROSS REFERENCE TO RELATED APPLICATIONS

The present application claims priority from, and incorporates by reference for any purpose the entire disclosure of U.S. Provisional Patent Application Ser. No. 60/964,093 filed Aug. 9, 2007, and U.S. Provisional Patent Application Ser. No. 60/959,975 filed Jul. 18, 2007.

### BACKGROUND

1. Technical Field

The present invention relates to a vehicular warning system indicating the presence of an occupant, and more particularly, but not by way of limitation, to a vehicle warning and alarm system, and method of signage, that includes both audio and visual indications of the presence of a young person, such as an infant within a vehicle once an ignition of the vehicle has been deactivated for a predetermined period of time. The present invention also relates to a method of signage, to indicate to other drivers, the presence of a young person, such as an infant, in a moving vehicle.

2. History of Related Art

The dangers associated with vehicles that have been parked and left with an occupant therein are well known. In recent years, a number of incidents have been publicized, reporting toddlers inadvertently left in a parked vehicle who subsequently died. The death of a toddler in the vehicle in such a manner is not only a tragedy, but also a situation that commands attention. In recent years, systems have been devised for addressing certain aspects of the presence of a toddler, and/or other individual with limited mobility within a vehicle. These systems have, in the main, addressed various aspects of parked vehicles. In particular, these systems have addressed the rapid increase in temperature therein during summer months. Among these developments are various methods and systems as represented by the following U.S. patents: U.S. Pat. No. 6,909,365 to Toles, U.S. Pat. No. 6,812,844 to Burgess, U.S. Pat. No. 6,535,137 to Ryan, U.S. Pat. No. 7,106,207 to Marchan, U.S. Pat. No. 5,793,291 to Thornton, and U.S. Patent Application Publication No. 2005/0200465 to Fabors et al.

U.S. Pat. No. 6,909,365 to Toles discloses, in one embodiment, a child safety seat comprising a safety-seat unit. An alarm is coupled to the safety-seat unit. The alarm unit sounds an alarm to remind occupants of a vehicle when a child is sitting in the child safety seat after an ignition of the vehicle is turned off.

U.S. Pat. No. 6,812,844 to Burgess discloses, in one embodiment, a child safety seat having alarms for use in connection with transporting infants in vehicles. The child safety seat with alarm has particular utility in connection with notifying a driver of a vehicle that an infant is in its carrier inside of the vehicle when a door is opened.

U.S. Pat. No. 6,535,137 to Ryan discloses, in one embodiment, a child-seat alarm including a car-seat portion adapted for being positioned within a motor vehicle. The car-seat portion includes child engagement straps. An alarm is disposed within the car-seat portion. The alarm includes a pair of speakers for broadcasting an audible alarm. The alarm is in an activated orientation when a male buckle is lockably received within a female receptacle. The alarm is in a deactivated orientation when the male buckle is removed from the female receptacle. The alarm is in communication with an electrical system of the vehicle whereby a shut down of the vehicle engine, or an opening of a driver's door, will sound the alarm when the alarm is in the activated orientation.

U.S. Pat. No. 7,106,207 to Marchan discloses, in one embodiment, an alarm including a pressure-actuated sensor positioned beneath a seat liner of a vehicle child seat. The sensor generates and transmits a signal when a threshold weight is detected and a door is ajar. A speaker receives the signal and emits an audible signal and continues to emit the signal until at least one sensor and push button switch are reset.

U.S. Pat. No. 5,793,291 to Thornton discloses, in one embodiment, an alarm system for detecting presence of a person locked in a parked automobile. The alarm system includes a motion detector and a temperature detecting element coupled to a NOR gate. The motion detector transmits a low signal to the NOR gate once it detects motion within an interior region of the automobile. The temperature detecting element transmits a low signal to the NOR gate if the temperature in the automobile exceeds a pre-determined extreme temperature. The NOR gate, upon receiving low signals from both the temperature detecting element and the motion detector, transmits an alarm signal.

U.S. Patent Application Publication No. 2005/0200465 to Fabors et al. discloses, in one embodiment, an alarm system for detecting the presence of a child being left unattended in a car seat inside a parked vehicle. The alarm includes a weight sensor and temperature monitoring device. The weight of the child activates the unit, which then begins monitoring an interior temperature of the vehicle. Should both the car seat be occupied and the interior temperature reach pre-determined danger levels, an alarm will be triggered.

One consideration that must be addressed is the situation where, for whatever reason, the vehicle driver does not want an alarm to sound as soon as the engine is turned-off. Some drivers may want to leave an occupant in a vehicle for a short period of time, such as when the vehicle driver is getting gas at a self-serve station. The present invention addresses certain disadvantages of the prior art by providing a single system capable of addressing the presence of an infant in a vehicle that is not running, while allowing some time to pass before an alarm sounds. After a predetermined period of time, the system of the present invention provides an alarm that is both audibly and visually capable of alerting individuals around the vehicle of a select condition.

### SUMMARY OF THE INVENTION

The present invention relates to a vehicular warning system indicating the presence of an individual within a vehicle. In one embodiment, after a given period of time that the vehicle is not in operation, an alarm is generated. More particularly, but not by way of limitation, one embodiment of the present invention pertains to a vehicular warning system, including both an audio and visual alert network, that will notify and warn individuals within the vicinity of the vehicle that an individual remains in the vehicle after a pre-determined time. The period of time may be adjusted and may be set, depending upon external environmental conditions such as temperature. The utilization of a dual audio and visual alert system should increase the reliability of such warning systems.

In another aspect, an embodiment of the present invention includes a vehicle alarm system for alerting occupants when an infant is left unattended on a child seat within a vehicle. The system comprising a plurality of buckles disposed on the child seat, at least one switch coupled to the plurality of buckles, a visual alerting device, a speaker, and wherein when at least one buckle of the plurality of buckles is engaged for a pre-determined time period after a vehicle ignition is turned off, the at least one switch transmits a signal activating the visual alerting device and the speaker.

In another aspect, an embodiment of the present invention includes a vehicle alarm system for alerting occupants when an infant is left unattended on a child seat within a vehicle. The system comprising a pressure-actuated sensor removably positioned beneath a seat liner of the child seat, at least one switch coupled to the child seat, a visual alerting device, a speaker, and wherein when the pressure-actuated sensor detects a threshold weight for a pre-determined time period after a vehicle ignition is turned off, the at least one switch transmits a signal activating the visual alerting device and the speaker.

In another aspect, an embodiment of the present invention includes a method of alerting occupants when an infant is left unattended on a child seat within a vehicle. The method comprising disposing a plurality of buckles on the child seat, coupling at least one switch to the plurality of buckles, determining if at least one buckle of the plurality of buckles is engaged for a pre-determined time period after a vehicle ignition is turned off and transmitting, via the at least one switch, a signal activating a visual alerting device and a speaker if the at least one buckle is engaged for pre-determined time period after the vehicle ignition is turned off.

In another aspect, an embodiment of the present invention includes a method of alerting occupants when an infant is left unattended on a child seat in a vehicle. The method comprising disposing a plurality of pressure-actuated sensors beneath the lining of the child seat, coupling at least one switch to the plurality of pressure-actuated sensors, determining if at least one sensor of the plurality of sensors is detects at least a minimum threshold weight for a pre-determined time period after a vehicle ignition is turned off, and transmitting, via the at least one switch, a signal activating a visual alerting device and a speaker if the at least one sensor detects at least a minimum threshold weight for pre-determined time period after the vehicle ignition is turned off.

In another aspect, an embodiment of the present invention includes a vehicle alarm system for alerting occupants when a passenger is left unattended within a vehicle. The system comprising a plurality of buckles disposed on a seat, at least one switch coupled to the plurality of buckles, a visual alerting device, a speaker and wherein when at least one buckle of the plurality of buckles is engaged for a pre-determined time period after a vehicle ignition is turned off, the at least one switch transmits a signal activating the visual alerting device and the speaker.

In another aspect, an embodiment of the present invention includes a vehicle alarm system for alerting occupants when a passenger is left unattended within a vehicle. The system comprising a plurality of pressure-actuated sensors disposed on a seat, at least one switch coupled to the plurality of pressure actuated sensors, a visual alerting device, a speaker and wherein when at least one sensor of the plurality of sensors is detects at least a minimum threshold weight for a pre-determined time period after a vehicle ignition is turned off, the at least one switch transmits a signal activating the visual alerting device and the speaker.

In another aspect, an embodiment of the present invention includes a method of signage for alerting occupants of other vehicles that a young person, such as a child, is present in a moving vehicle. The system comprising a plurality of buckles disposed on a seat, at least one switch coupled to the plurality of buckles, a visual alerting device and wherein when at least one buckle of the plurality of buckles is engaged after a vehicle ignition is turned on, the at least one switch transmits a signal activating the visual alerting device. The visual alerting device may be rotationally coupled to a motor, and thereby capable of movement between a stowed position and an activated position. If a young person is not in the vehicle, or if the vehicle ignition is not turned on, visual alerting device will remain in a stowed position.

In another aspect, an embodiment of the present invention includes a method for signage of alerting occupants of other vehicles that a young person, such as a child, is present in a moving vehicle. The system comprising a pressure-actuated sensor removably positioned beneath a seat liner of the child seat, at least one switch coupled to the child seat, a visual alerting device, and wherein when the pressure-actuated sensor detects a threshold weight after a vehicle ignition is turned on, the at least one switch transmits a signal activating the visual alerting device.

In another aspect, an embodiment of the present invention includes a method of signage for alerting occupants of other vehicles that a young person, such as a child, is present in a moving vehicle. The system comprising a visual alerting device that is rotationally coupled to a linear DC motor.

The above summary of the invention is not intended to represent each embodiment or every aspect of the present invention.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1A is a diagrammatic illustration of an alarm system according to an embodiment of the present invention.

FIG. 1B is a simplified diagrammatic illustration of an alarm system according to an embodiment of the present invention.

FIG. 1C is a diagrammatic illustration of the alarm system of FIG. 1A having an alternative visual alerting device.

FIG. 1D is a diagrammatic illustration of the alarm system of FIG. 1A having an alternative visual alerting device

FIG. 2A is a diagrammatic illustration of an alarm system according to an alternate embodiment of the present invention.

FIG. 2B is a simplified diagrammatic illustration of an alarm system according to an alternate embodiment of the present invention.

FIG. 2C is a diagrammatic illustration of the alarm system of FIG. 2A having an alternative visual alerting device.

FIG. 2D is a diagrammatic illustration of the alarm system of FIG. 2a having an alternative visual alerting device.

FIG. 3 is a flow-diagram according to an embodiment of the present invention.

FIG. 4 is a flow-diagram according to an alternate embodiment of the present invention.

FIG. 5A is a front view of a vehicle having an alarm system according to an embodiment of the present invention.

FIG. 5B is a front view of a vehicle having an alarm system according to an alternative embodiment of the present invention.

FIG. 5C is a rear view of a vehicle having an alarm system according to an embodiment of the present invention.

FIG. 5D is a rear view of a vehicle having an alarm system according to an alternative embodiment of the present invention.

FIG. 6 is a perspective view of a child safety seat installed in the rear seat of a vehicle according to an embodiment of the present invention.

FIG. 7 is a flow-diagram according to an alternate embodiment of the present invention.

FIG. 8. is a diagrammatic illustration of an alarm system according to an alternate embodiment of the present invention.

FIG. 9 is a side view of the visual alerting device of FIG. 9 powered by a linear DC motor.

### DETAILED DESCRIPTION OF ILLUSTRATIVE EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims and the equivalents thereof.

The present invention is directed toward a vehicle alarm system incorporating both auditory and visual alert networks. The alarm system is formatted in a configuration allowing actuation after a pre-determined period of time following turning off the ignition of a vehicle. The following description of embodiments of the application are thus presented in accordance with the principles as currently understood by the inventor at the time of filing.

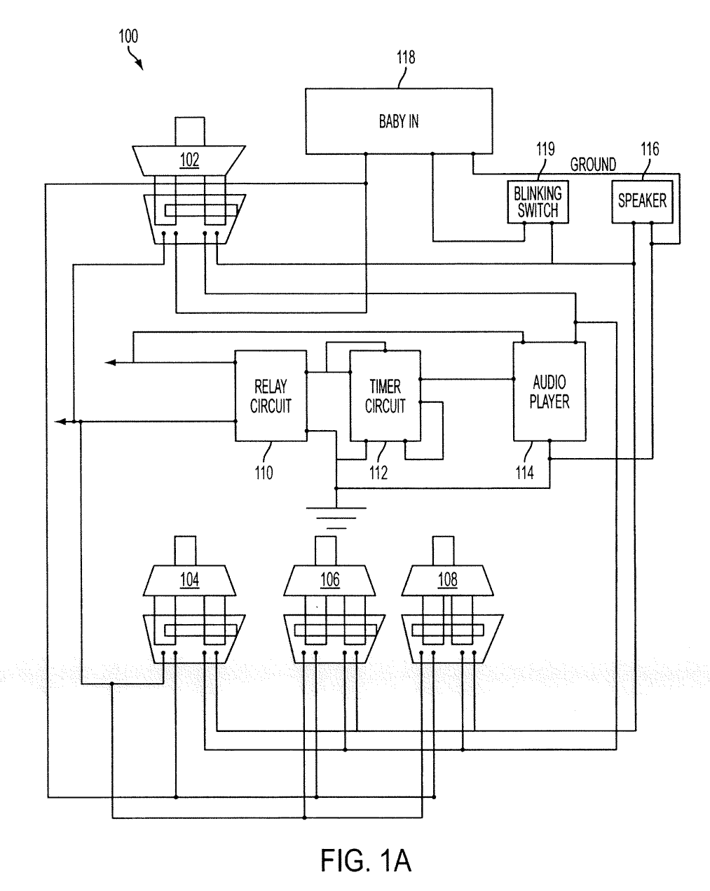

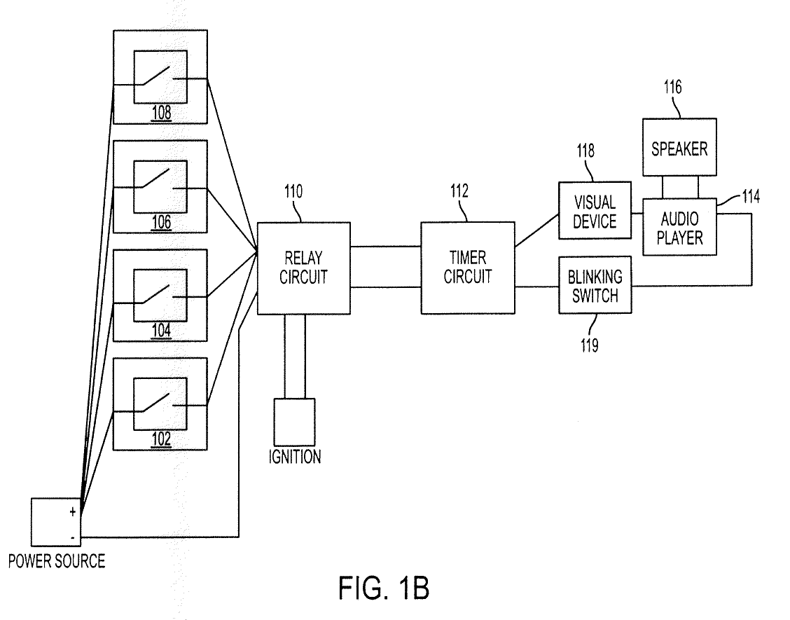

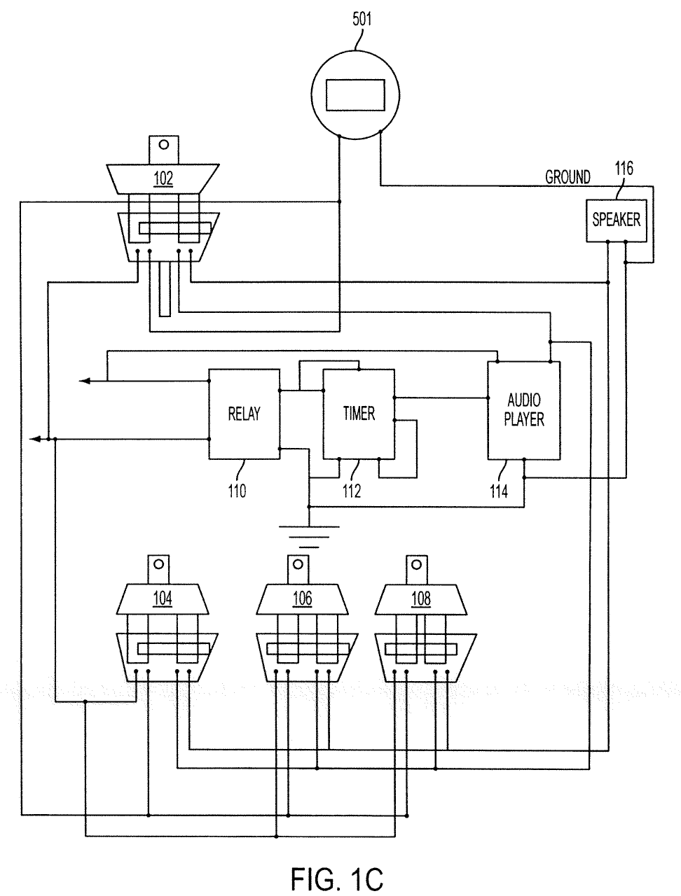

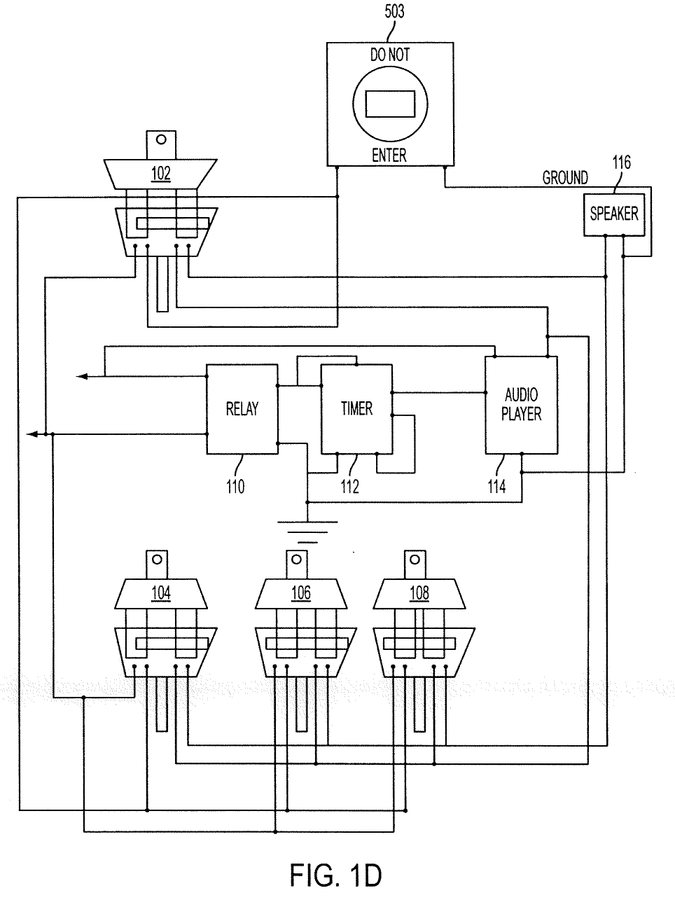

Referring first to FIG. 1, there is shown a diagramatic illustration of a vehicle containing an alarm system 100 constructed in accordance with an embodiment of the present invention. The alarm system 100 includes a visual alerting device 118 situated in a windshield area of the vehicle so as to be observable to other individuals around the vehicle if activated. The alarm system 100 further includes a plurality of buckles 102, 104, 106, 108. The plurality of buckles 102, 104, 106, 108 may be, for example, seat-belt buckles within the vehicle, or may be buckles present on child safety seats installed within the vehicle. Each buckle of the plurality of buckles 102, 104, 106, 108 is connected in parallel to alarm system 100, and each is adapted to connect alarm system 100 to a power source, when in an engaged position. The electrical connection may be accomplished through any appropriate means, but is most preferably accomplished via either a simple switch or standard relay disposed within each buckle of the plurality of buckles 102, 104, 106, 108. The alarm system 100 further includes a relay circuit 110, a timer circuit 112, and an audio player 114 within the vehicle. The relay circuit 110 and the timer circuit 112 are connected in series connection. The timer circuit 112 may be, for example, a cascading or sequential timer, such as the model H3CA-A solid state timer available from Omron Corporation of Kyoto, Japan, or any functional equivalent thereof. In use, the above referenced timer should be set to “F” mode to allow one-shot and flicker operation or any functional equivalent thereof. The relay circuit 110 is electrically coupled to a power source, and facilitates powering or energizing the alarm system 100. The relay circuit may be, for example, a well-known relay including a magnetic coil which is charged when voltage is applied across the coil.

According to an embodiment of the present invention, the alarm system 100 includes a switch 119. The switch 119 is coupled to the plurality of buckles 102, 104, 106, 108. When at least one buckle of the plurality of buckles 102, 104, 106, 108 is engaged while the vehicle ignition is turned off, the switch 119 is activated. The switch 119 in the activated state sends a signal to activate both the visual alerting device 118 and the speaker 116. According to an embodiment of the present invention, visual alerting device 118 includes a clear box which, by way of example only, says “BABY IN”. The visual alerting device 118 may be adapted to house one or more light bulbs.

In operation, when the vehicle ignition is turned on, and an infant is sitting on the child safety seat in the vehicle, or if the infant and/or an elderly person is sitting on the vehicle seats with at least one buckle of the plurality of buckles 102, 104, 106, 108 in an engaged position, timer circuit 112 is not activated and no signal is transmitted to the speaker 116 and the visual alerting device 118. However, when the vehicle's ignition is turned off, and if at least one buckle of the plurality of buckles 102, 104, 106, 108 remains in an engaged position, as would be the case if an adult were to leave a small child in the vehicle, the timer circuit 112 is activated. The timer circuit 112 starts to count for a pre-determined time period after which, if the vehicle's ignition is still turned off and if at least one buckle of the plurality of buckles 102, 104, 106, 108 is still in the engaged position, a signal is transmitted causing the visual alerting device 118 to illuminate. The signal also activates audio player 114 to broadcast an audible message via the speaker 116 to alert the vehicle owner, or passerbys, about the infant and/or elderly person being in the vehicle. By way of example only, the inventor herein has suggested the following message could be broadcast:

“Please help me! My mommy left me in the car, and I don't want to die! Help me please!”

The alarm system 100 will continue to remind occupants that the infant and/or elderly person is in the car via the visual alerting device 118, and the message broadcast via the speaker 116, for approximately 7-10 minutes, or until each of the plurality of buckles 102, 104, 106, 108 are opened and placed in a disengaged position, thereby indicating that the child has been removed from the vehicle. The speaker 116 is disposed for broadcasting an audible alert outwardly of the vehicle in the event of the actuation of the alarm system 100. As a further safety measure, contact information for the child's parents, such as home and mobile phone numbers, should be placed near the child safety seat. By way of example, such information could be stored in the seat-back pocket of the seat immediately in front of the child safety seat.

According to an embodiment, within the vehicle, the alarm system 100 incorporates a plurality of sensors to indicate the presence of an individual within the vehicle after a prolong period of time following the stopping of the vehicle and turning off the ignition.

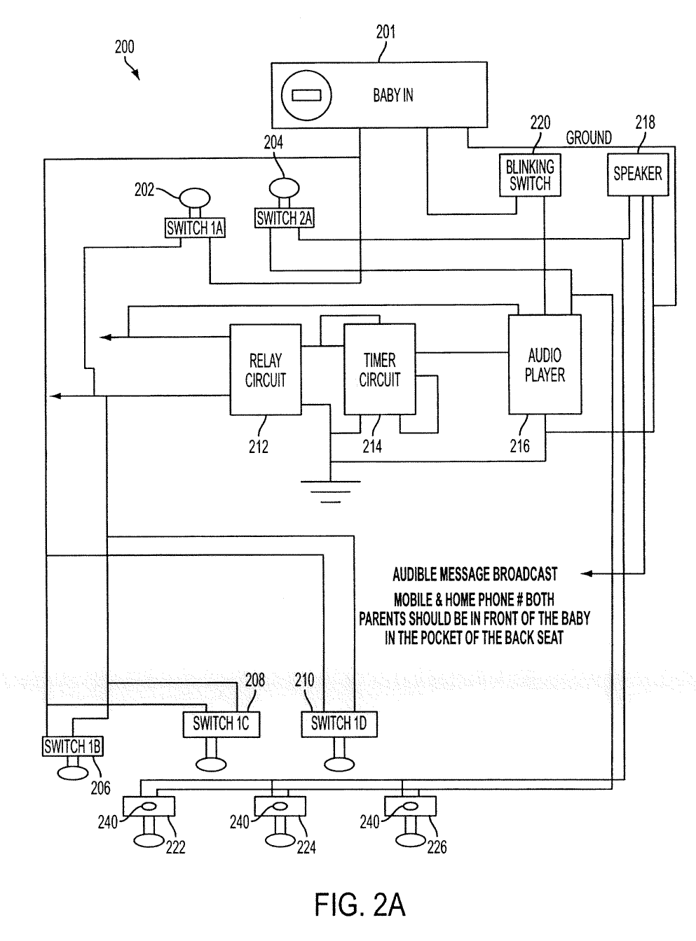

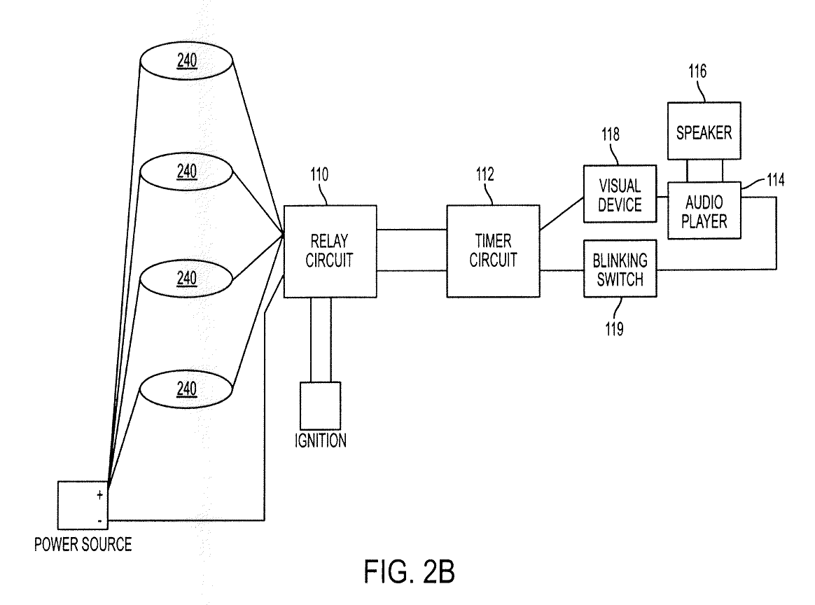

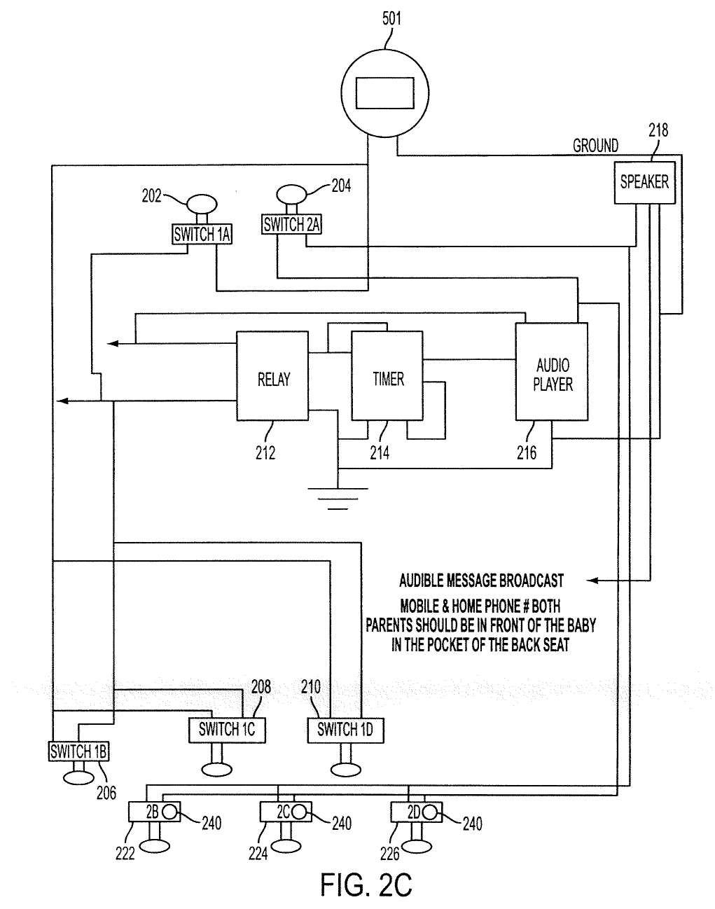

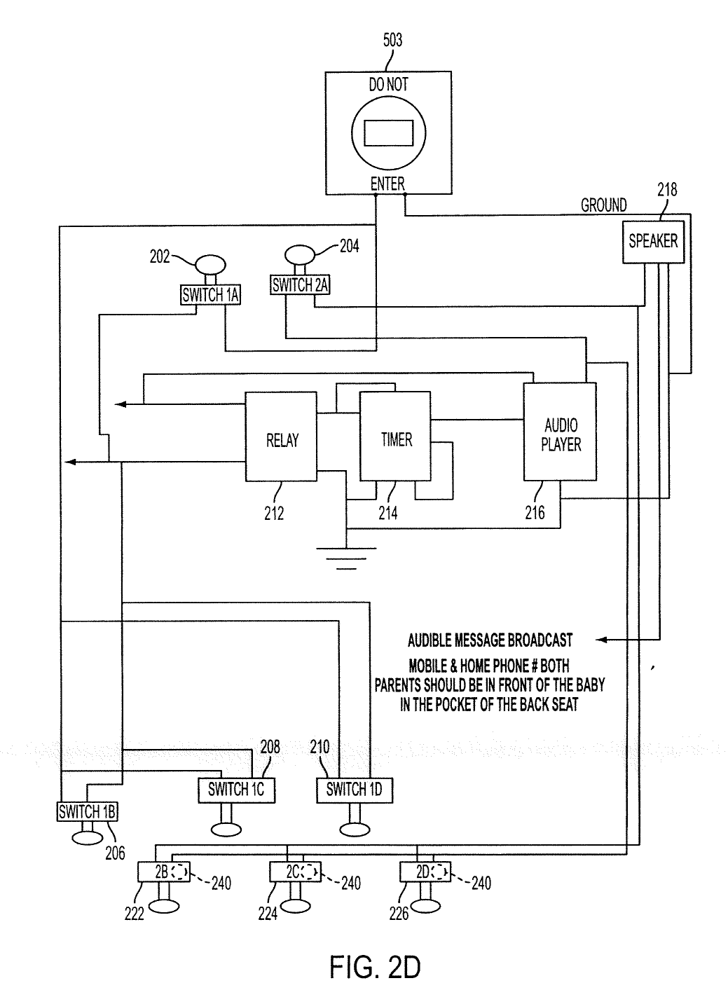

Referring to FIG. 2, there is shown a diagrammatic illustration of a vehicle containing an alarm system 200 constructed in accordance with an additional embodiment. The alarm system 200 includes a visual alerting device 201 situated in a front or rear windshield area of the vehicle to allow other individuals around the vehicle to observe the visual alerting device 201 if activated. The alarm system 200 further includes a plurality of switches 202, 204, 206, 208, 210. The alarm system 200 further includes a relay circuit 212, a timer circuit 214, and an audio player 216 within the vehicle. The alarm system further illustrates a plurality of child safety seats 222, 224, 226. It is further contemplated that alarm system 200 could be used in conjunction with the existing vehicle seats instead of a child safety seat. The relay circuit 212 and the timer circuit 214 are connected in series connection. The timer circuit 214 may be, for example, a cascading or sequential timer, such as the model H3CA-A solid state timer available from Omron Corporation of Kyoto, Japan, or any functional equivalent thereof. In use, the above referenced timer should be set to “F” mode to allow one-shot and flicker operation or any functional equivalent thereof. The relay circuit 212 is electrically coupled to a power source, and facilitates powering or energizing the alarm system 200. The relay circuit may be, for example, a well-known relay including a magnetic coil which is charged when voltage is applied across the coil.

According to an embodiment, the alarm system 200 includes a blinking switch 220. The plurality of child safety seats 222, 224, 226 each include a pressure-actuated sensor 240 removably positioned beneath a seat liner of the child safety seat. The sensor 240 includes a cover formed from flexible and water-resistant material positioned thereabout that is essential for effectively and advantageously shielding the pressure-actuated sensor 240.

A speaker 218 is electrically coupled to the pressure-actuated sensor 240. The speaker 218 is disposed for broadcasting an audible alert outwardly of the vehicle in the event of the actuation of the alarm system 200.

In operation, when the vehicle ignition is turned on, and an infant is sitting on the child safety seat in the vehicle, or if the infant and/or an elderly person is sitting on the vehicle seat, timer circuit 112 is not activated and no signal is transmitted to the speaker 218 and the visual alerting device 201. However, when the vehicle's ignition is turned off, and if the pressure-actuated sensor 240 detects a threshold weight, as would be the case if an adult were to leave a small child in the vehicle, a signal is generated and transmitted activating the timer circuit 214. The timer circuit 214 starts to count for a pre-determined time period after which, if the vehicle's ignition is still turned off and if the pressure-actuated sensor 240 still detects a threshold weight, a signal is transmitted causing the visual alerting device 201 to illuminate. The signal also activates audio player 114 to broadcast an audible message, as described above, via the speaker 218, to remind occupants in the vehicles, or passersby, that the infant and/or elderly person is still in the vehicle. The alarm system 200 will continue to remind occupants that the infant is in the car via the visual alerting device 201 and the audible sound via the speaker 218 for approximately 7-10 minutes, or until the pressure-actuated sensor 240 fails to detect a threshold weight thereby indicating that the child has been removed from the vehicle. As previously described, contact information for the child's parents, such as home and mobile phone numbers, should be placed near the child safety seat. By way of example, such information could be stored in the seat-back pocket of the seat immediately in front of the child safety seat.

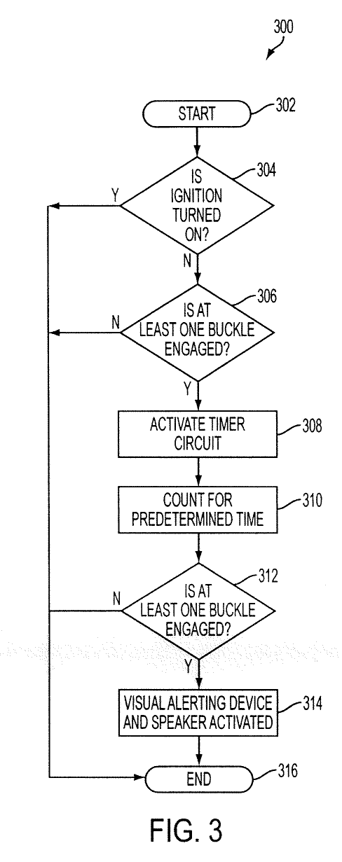

FIG. 3 illustrates a flow-diagram according to an embodiment of the present invention. The process 300 starts at step 302. At step 304 it is determined if a vehicle ignition is turned on. If it is determined at step 304 that the vehicle ignition is turned on, the process ends at step 316. However, if it is determined at step 304 that the vehicle ignition is turned off, the process 300 proceeds to step 306. At step 306 it is determined if at least one buckle of the plurality of buckles 102, 104, 106, 108 is engaged. The at least one buckle 102, 104, 106, 108 may be for example, a seat-belt buckle within the vehicle, or a buckle present on child safety seats. If it is determined at step 306 that none of the buckles 102, 104, 106, 108 are engaged, the process ends at step 316. However, if it is determined at step 306 that at least one buckle 102, 104, 106, 108 is engaged, the process 300 proceeds to step 308.

At step 308, timer circuit 112 is activated. The timer circuit 112 starts to count for a pre-determined time period at step 310. At step 312, it is determined if at least one buckle 102, 104, 106, 108 remains in the engaged position. If it is determined at step 312 that none of the buckles 102, 104, 106, 108 are engaged, the process ends at step 316. However, if it is determined at step 312 that at least one buckle 102, 104, 106, 108 remains engaged, the process 300 proceeds to step 314. At step 314, the visual alerting device 118 is activated to illuminate. Also, at step 314, the audio player is also activated to transmit, via the speaker, an audible sound to remind occupants in the vehicles, or passerbys, that an infant and/or elderly person may be in the vehicle. The process ends at step 316.

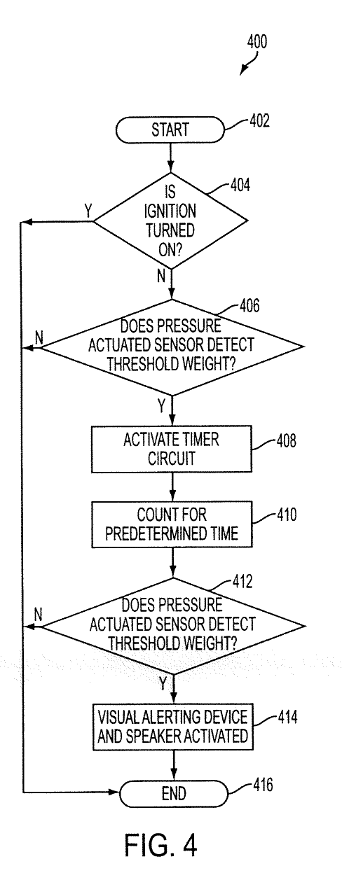

FIG. 4 illustrates a flow-diagram according to an alternate embodiment of the present invention. The process 400 starts at step 402. At step 404 it is determined if a vehicle ignition is turned on. If it is determined at step 404 that the vehicle ignition is turned-on, the process ends at step 416. However, if it is determined at step 404 that the vehicle ignition is turned off, the process 400 proceeds to step 406. At step 406 it is determined if a pressure-actuated sensor 240 detects a threshold weight. If it is determined at step 406 that the pressure-actuated sensor 240 fails to detects the threshold weight, the process 400 ends at step 416. However, if it is determined at step 406 that the pressure-actuated sensor 240 detects a threshold weight, the process 400 proceeds to step 408.

At step 408, timer circuit 214 is activated. The timer circuit 214 starts to count for a pre-determined time period at step 410. At step 412, it is determined if the pressure-actuated sensor 240 still detects a threshold weight. If it is determined at step 412 that the pressure-actuated sensor 240 fails to detects the threshold weight, the process 400 ends at step 416. However, if it is determined at step 412 that the pressure-actuated sensor 240 still detects the threshold weight, the process 400 proceeds to step 414. At step 414, the visual alerting device 201 is activated to illuminate. At step 414, the speaker 218 is also activated to transmit an audible sound to remind occupants in the vehicles, or passerbys, that an infant and/or elderly person may be in the vehicle. The process ends at step 416.

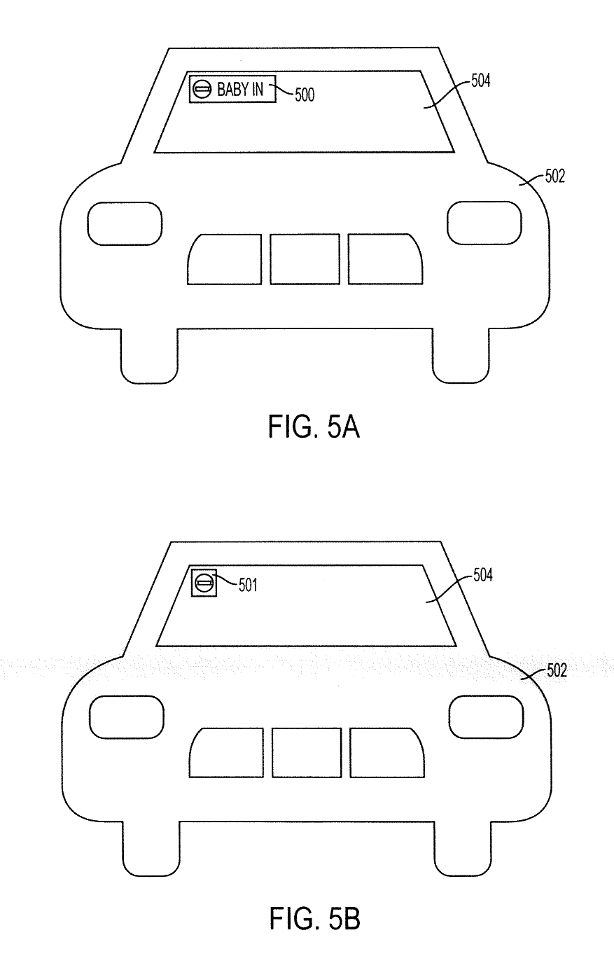

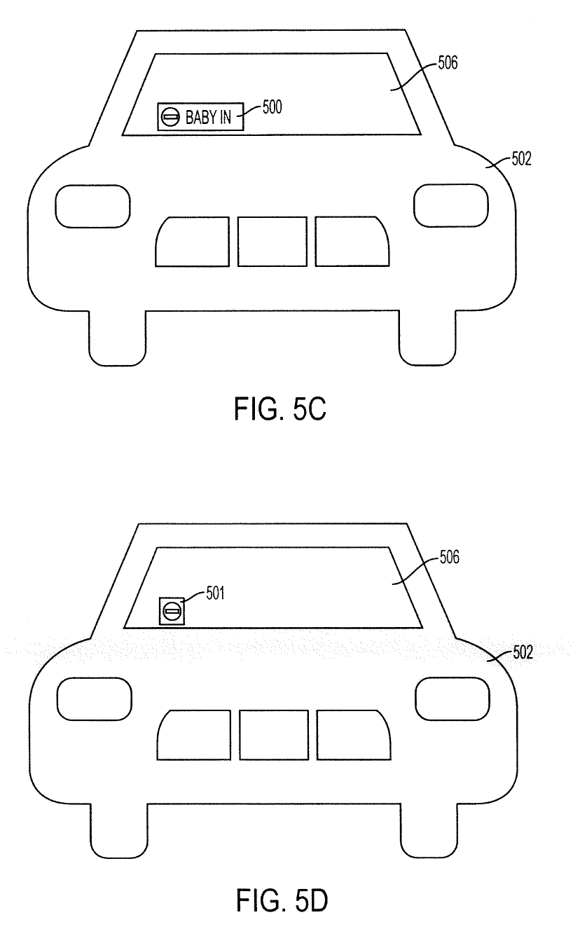

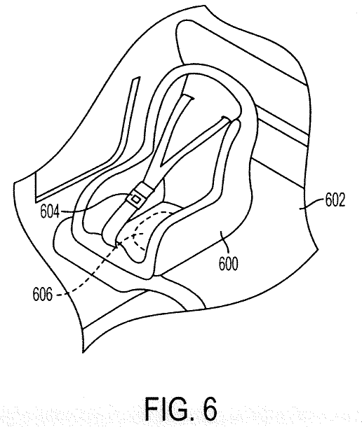

FIGS. 5A, 5B, 5C and 5D illustrate the placement of visual alerting device 500 within vehicle 502. Visual alerting device 500 may be placed in the front windshield 504 of vehicle 502, as shown in FIG. 5A. By way of example, visual alerting device 500 is shown in FIG. 5A placed in the upper, passenger-side portion of front windshield 504. However, visual alerting device may be located at any safe place on front windshield 504. FIG. 5B shows an alternative visual alerting device 501 placed in the passenger side front windshield 504 of vehicle 502. Alternative visual alerting device 501 has a smaller footprint area than visual alerting device 500. By way of example, alternative visual alerting device 501 could be used if visual alerting device 500 is too large to attach to the exterior-facing side of the passenger-side sun visor, or if visual alerting device 500 obstructs the drivers field of vision to an unsafe degree. By way of example, visual alerting device is shown in FIG. 5B as having no text. Alternatively, alternative visual alerting device 503 could have a textual message, as shown in FIGS. 1D and 2D. By way of example only, the textual message shown in FIGS. 1D and 2D is Do Not Enter. However, any appropriate message may be used. Visual alerting device 500 also may be additionally, or alternatively, placed in the rear windshield 506 of vehicle 502. Again, by way of example, visual alerting device 500 is shown in FIG. 5C placed in the lower, driver-side portion of rear windshield 506. However, visual alerting device may be located at any safe place on rear windshield 506. FIG. 5D shows an alternative visual alerting device 501 placed in the rear windshield 506 of vehicle 502. Alternative visual alerting device 501 has a smaller footprint area than visual alerting device 500. By way of example, alternative visual alerting device 501 could be used if visual alerting device 500 is too large to attach to rear windshield 506, or if visual alerting device 500 obstructs the drivers field of vision to an unsafe degree.

FIG. 6 illustrates the placement of child safety seat 600 in vehicle 602. An alarm system of the type herein described may be actuated through buckle 604. In addition, the alarm system of the present invention may be alternatively, or additionally, actuated via a pressure sensitive switch 606 located within a cushion of child safety seat 600.

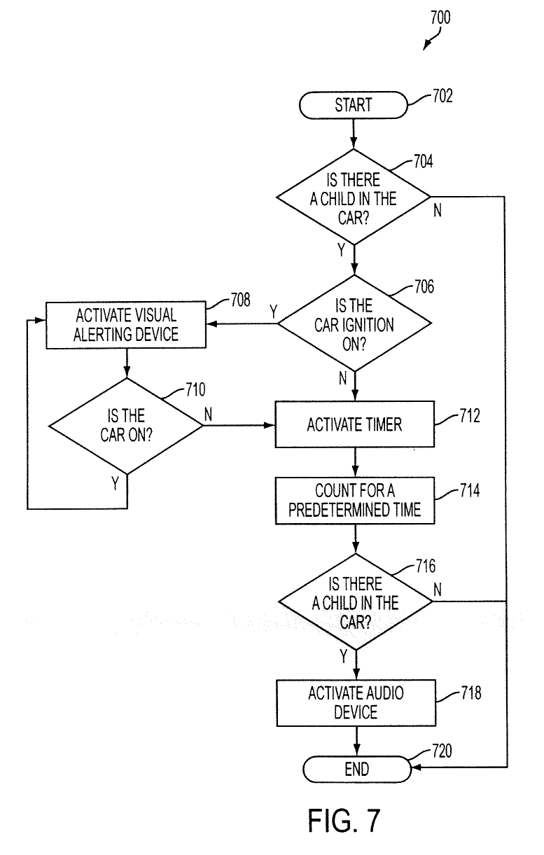

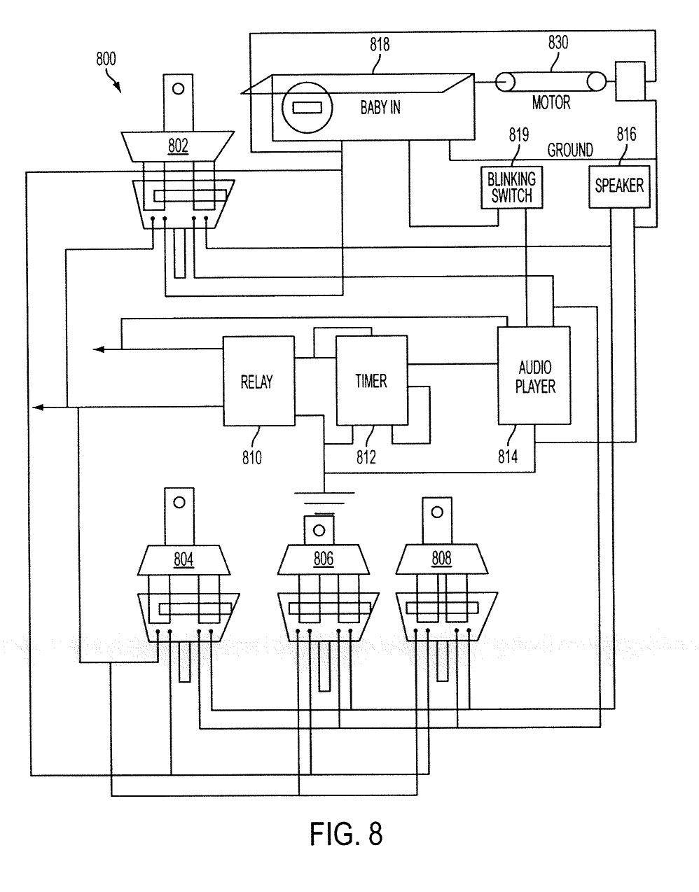

Referring now to FIGS. 7 and 8, there is shown an embodiment of the present invention where visual alerting device 818 is used, while the vehicle is in motion, to alert drivers of other vehicles that a child is in the vehicle. Referring specifically to FIG. 7, the process 700 starts at step 702. At step 704, it is determined if a child is in the vehicle. Step 704 may be accomplished by any of the methods described hereinabove including, but not limited to, coupling a switch to each seat-belt or child-safety-seat buckles, or using pressure actuated sensors. If it is determined in step 704 that a child is not present in the car, the process 700 ends at step 720. On the other hand, if it is determined in step 704 that a child is present in the vehicle, the process 700 proceeds to step 706 where it is determined if the vehicle ignition is turned on. If it is determined in step 706 that the vehicle ignition is turned on, the process 700 proceeds to step 708, where visual alerting device 818 is illuminated to alert other drivers that a child is present in the vehicle. Visual alerting device 818 will remain activated as long as the vehicle ignition is turned on with a child present therein. If at any point the vehicle ignition is turned off, with the child remaining inside, the process proceeds to step 712. At step 712 the timer circuit 112 is activated as described hereinabove. The timer circuit starts to count for a predetermined period at step 714. At step 716, if it is again determined that a child is present in car, the process 700 proceeds to step 718. At step 718 the speaker is activated to transmit an audible sound to remind occupants that an infant or child may be in the vehicle. Also at step 718, blinking switch 819 will begin to blink to alert third parties to the presence of the child in the vehicle. Blinking switch 819 may be displayed in either the front, rear, or sides of the vehicle. Alternatively, several blinking switches 819 could be integrated with the same system 800. The process ends at step 720.

Referring specifically to FIG. 8 there is shown a diagrammatic illustration of a vehicle containing an alarm system 800 constructed in accordance with an alternate embodiment of the present invention. The alarm system 800 includes a visual alerting device 818 situated in a windshield area of the vehicle to allow other individuals around the vehicle to observe the visual alerting device 818 if activated. The alarm system 800 further includes a plurality of switches 802, 804, 806, 808. The alarm system 800 further includes a relay circuit 810, a timer circuit 812, and an audio player 814 within the vehicle. It is further contemplated that the alarm system 800 could be used in conjunction with the existing vehicle seats instead of a child safety seat. The relay circuit 810 and the timer circuit 812 are connected in series connection. The timer circuit 812 may be, for example, a cascading or sequential timer, such as the model H3CA-A solid state timer available from Omron Corporation of Kyoto, Japan, or any functional equivalent thereof. In use, the above referenced timer should be set to “F” mode to allow one-shot and flicker operation or any functional equivalent thereof. The relay circuit 810 is electrically coupled to a power source and facilitates powering or energizing the alarm system 800. The relay circuit may be, for example, a well-known relay including a magnetic coil which is charged when voltage is applied across the coil.

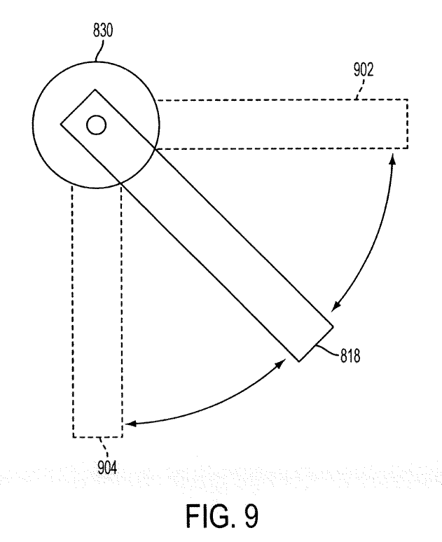

During operation, visual alerting device is illuminated any time a child is present in the vehicle with the ignition turned on, thereby providing a visual alert to other motorist of the presence of a child in the vehicle. If there if no child in the car, or if the vehicle ignition is turned off and the child is removed, visual alerting device 818 is deactivated. By way of example, visual alerting device 818 is shown in FIG. 8 as being capable of rotating between an activated position 904 and a stowed inactive position 902. Again, by way of example, visual alerting device is shown in FIGS. 8 and 9 as being powered by a linear DC motor 830. If no child is present in the vehicle, or if the vehicle ignition is turned off, visual alerting device 830 will remain in the stowed position 902. However, if the vehicle ignition is turned on while a child is in the vehicle, visual alerting device will move to the activated position and illuminate. The movement of the motor could be stopped by a limit switch, or any other appropriate mechanism. If the child is removed from the vehicle, or if the vehicle ignition is turned off, motor 830 will move visual alerting device back into stowed position 902. In one embodiment, this could be accomplished through the use of a second timer such that when the vehicle ignition is turned off, the second timer will continue to provide power to the motor long enough to move visual alerting device back into stowed position 902. Alternatively, the same function could be accomplished by using a second relay and a second limit switch. In this case, turning off the ignition would activate the second relay and close the circuit to the motor 830. Motor 830 would begin to move the visual alerting device. When visual alerting device reaches stowed position 902, it contacts a second limit switch which opens the circuit, and stops the motion. By way of example, motor 830 could be any reversible motor available from Hing Lung Motor Mfy. of Hong Kong, China or any functional equivalent thereof.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed:

1. A vehicle alarm system of the type useful for alerting occupants when a person is left unattended in a vehicle, the system comprising:
at least one switch disposed proximate to a seat within the vehicle, the at least one switch electrically coupled to a power source;
a visual alerting device, rotatable between a stowed position and an activated position, the visual alerting device electrically coupled to the power source and the at least one switch;
contact information for at least one responsible adult disposed proximate to the seat; and
wherein, when the at least one switch remains in a closed position for a pre-determined period of time after a vehicle ignition is turned off, the at least one switch transmits a signal activating the visual alerting device.

2. The system of claim 1, wherein the at least one switch is coupled to a plurality of buckles within the vehicle.

3. The system of claim 1, wherein the at least one switch comprises a pressure-actuated sensor removably disposed beneath a seat lining within the vehicle.

4. The system of claim 1, wherein the rotation of the visual alerting device is powered by a linear DC motor.

5. The system of claim 1, wherein the visual alerting device is disposed so as to be visible to an interior of the vehicle and an exterior of the vehicle.

6. The system of claim 1, further comprising an audio player, the audio player electrically connected to a speaker, the audio player operative to broadcast, via the speaker, an audible alert outwardly of the vehicle.

7. The system of claim 6, wherein the audible alert comprises a pre-recorded spoken voice message.

8. The system of claim 1, wherein the person is an infant or child.

9. The system of claim 1, wherein the person is an adult with a physical limitation preventing him from exiting the vehicle.

10. The system of claim 1, wherein the seat is a child safety seat.

11. The system of claim 1, wherein the seat is a standard vehicle seat.

12. The system of claim 1, wherein the contact information comprises a card, conspicuously stored near the seat, the card displaying home and mobile phone numbers of at least one adult who is responsible for the person.

13. The system of claim 1, wherein the pre-determined time period is set by a user.

14. A system for alerting other drivers of the presence of an infant or child in a moving vehicle, the system comprising:
at least one switch disposed proximate to a seat within the vehicle, the at least one switch electrically coupled to a power source;
a visual alerting device, rotatable between a stowed position and an activated position, the visual alerting device electrically coupled to the power source and the at least one switch; and
wherein when the at least one switch remains in a closed position while a vehicle engine is running, the at least one switch transmits a signal activating the visual alerting device.

15. The system of claim 14, wherein the at least one switch is coupled to a plurality of buckles within the vehicle.

16. The system of claim 14, wherein the at least one switch comprises a pressure-actuated sensor removably disposed beneath a seat lining within the vehicle.

17. The system of claim 14, wherein the rotation of the visual alerting device is powered by a linear DC motor.

18. The system of claim 14, wherein the visual alerting device is disposed so as to be visible to an interior of the vehicle and an exterior of the vehicle.

19. A method for alerting occupants of a vehicle, or individuals near the vehicle, when a person is left unattended in a vehicle, the method comprising:
determining if the person has remained in the vehicle for a pre-determined period of time after a vehicle ignition has been turned off;
transmitting a signal operative to illuminate a visual alerting device and rotate the visual alerting device from a stowed position to an activated position if the person is present in the vehicle for longer that the pre-determined time period; and
providing contact information for at least one adult who is responsible for the person.

20. The method of claim 19, wherein the person is an infant or child.

21. The method of claim 19, wherein the person is an adult with a physical limitation preventing him from exiting the vehicle.

22. The method of claim 19, wherein the rotation of the visual alerting device is powered by a linear DC motor.

23. The method of claim 19, further comprising activating an audio player if the person is present in the vehicle for longer that the pre-determined time period, the audio player electrically connected to a speaker, the audio player operative to broadcast, via the speaker, an audible alert outwardly of the vehicle.

24. The system of claim 23, wherein the audible alert comprises a pre-recorded spoken voice message.

25. The method of claim 19, wherein the pre-determined time period is set by a user;

26. The method of claim 19, wherein the visual alerting device is disposed so as to be visible to an interior of the vehicle and an exterior of the vehicle.

27. The method of claim 19, wherein the contact information comprises a card, conspicuously stored near the seat, the card displaying home and mobile phone numbers of at least one adult who is responsible for the person.

28. The method of claim 19, wherein the step of determining if the person has remained in the vehicle further comprises:
disposing a plurality of buckles on a seat;
coupling at least one switch to the plurality of buckles;
determining if at least one buckle of the plurality of buckles is engaged for a pre-determined time period after a vehicle ignition is turned off; and
transmitting, via the at least one switch, a signal activating the visual alerting device and the audio player if the at least one buckle is engaged for the pre-determined time period after the vehicle ignition is turned off.

29. The method of claim 28, wherein the seat is a standard vehicle seat.

30. The method of claim 28, wherein the seat is a child safety seat.

31. The method of claim 19, wherein the step of determining if the person has remained in the vehicle further comprises:
disposing a plurality of pressure-actuated sensors within the lining of a seat;
coupling at least one switch to the plurality of pressure-actuated sensors;
determining if at least one pressure-actuated sensor of the plurality of pressure-actuated sensors is activated for a pre-determined period of time after a vehicle ignition is turned off; and
transmitting, via the as least one switch, a signal activating the visual alerting device and the audio player if the at least one pressure-actuated sensor is activated for the pre-determined time period after the vehicle ignition is turned off.

32. The method of claim 31, wherein the seat is a standard vehicle seat.

33. The method of claim 31, wherein the seat is a child safety seat.

34. A method for alerting other drivers of the presence of an infant or child in a moving vehicle, the method comprising:
determining if the infant or child is in the vehicle while a vehicle engine is running;
transmitting a signal operative to illuminate a visual alerting device and rotate the visual alerting device from a stowed position to an activated position.

35. The method of claim 34, wherein the rotation of the visual alerting device is powered by a linear DC motor.

36. The method of claim 34, wherein the visual alerting device is disposed so as to be visible to an interior of the vehicle and an exterior of the vehicle.

37. The method of claim 34, wherein the step of determining if the person has remained in the vehicle further comprises:
disposing a plurality of buckles on a seat;
coupling at least one switch to the plurality of buckles;
determining if at least one buckle of the plurality of buckles is engaged for a pre-determined time period after a vehicle ignition is turned off; and
transmitting, via the at least one switch, a signal activating the visual alerting device and the audio player if the at least one buckle is engaged for the pre-determined time period after the vehicle ignition is turned off.

38. The method of claim 37, wherein the seat is a standard vehicle seat.

39. The method of claim 37, wherein the seat is a child safety seat.

40. The method of claim 34, wherein the step of determining if the person has remained in the vehicle further comprises:
disposing a plurality of pressure-actuated sensors within the lining of a seat;
coupling at least one switch to the plurality of pressure-actuated sensors;
determining if at least one pressure-actuated sensor of the plurality of pressure-actuated sensors is activated for a pre-determined period of time after a vehicle ignition is turned off; and
transmitting, via the as least one switch, a signal activating the visual alerting device and the audio player if the at least one pressure-actuated sensor is activated for the pre-determined time period after the vehicle ignition is turned off.

41. The method of claim 40, wherein the seat is a standard vehicle seat.

42. The method of claim 40, wherein the seat is a child safety seat.
